(19) United States
(12) Patent Application Publication
(10) Pub. No.: US 2013/0111068 A1
(43) Pub. Date: May 2, 2013

(54) Creating an optimized distribution network for the efficient transfer of data between endpoints using crossover connections

(71) Applicants: Gabor Tyukasz, Budapest (HU); Krisztian Kopasz, Budapest (HU); Marton B. Anka, Windham, NH (US)

(72) Inventors: Gabor Tyukasz, Budapest (HU); Krisztian Kopasz, Budapest (HU); Marton B. Anka, Windham, NH (US)

(73) Assignee: LOGMEIN, INC., Woburn, MA (US)

(21) Appl. No.: 13/284,211

(22) Filed: Oct. 28, 2011

(51) Int. Cl. G06F 15/16

(52) U.S. Cl. 709/248

(57) ABSTRACT

A method is operated at a coordinating entity to organize a set of hosts into a “synchronization” network. The coordinating entity maintains information that a particular host is online and available to be organized into the network. To that end, the coordinating entity assigns an identifier (a node identifier) to each host that is online, and that identifier is unique within the particular network. The coordinating entity orders the node identifiers for the set of hosts (based on a given characteristic of the node identifiers). In one embodiment, the ordering organizes the synchronization network in a circle. Based on the ordering, the coordinating entity provides each host that is online with a list of K online hosts to enable each host to establish and maintain connections with K of its neighbor hosts. In this scheme, K is a value that is the same for all hosts within the synchronization network. For larger networks, crossover connections may be implemented to improve performance.

### BACKGROUND

1. Technical Field

This disclosure relates generally to distributed computer networks and in particular to techniques for maintaining the contents of selected objects (e.g., directories, files, and the like) in synchronization (“sync”) across multiple participating computers (a “sync network”).

2. Background of the Related Art

Remote access technologies, products and systems enable a user of a remote computer to access and control a host computer over a network. Internet-accessible architectures that provide their users with remote access capabilities (e.g., remote control, file transfer, display screen sharing, chat, computer management and the like) also are well-known in the prior art. Typically, these architectures are implemented as a Web-based “service,” such as LogMeIn, GoToMyPC, WebEx, Adobe Connect, and others. An individual (or subscriber) who uses the service has a host computer that he or she desires to access from a remote location. Using the LogMeln service, for example, the individual can access his or her host computer using a client computer that runs web browser software.

Peer-to-peer (P2P) computing or networking is a distributed application architecture that partitions tasks or workloads among peers. Peers are equally privileged, equipotent participants in the application. They form a peer-to-peer network of nodes. Peers make a portion of their resources, such as processing power, disk storage or network bandwidth, directly available to other network participants, without the need for central coordination.

A real-time file synchronization application that ensures selected storage objects (e.g., folders or files) always have identical content on all participating computers generates significant network traffic, and keeping such a highly-volatile network connected demands substantial computational power and bandwidth.

### BRIEF SUMMARY

This disclosure describes a technique to build an optimal network that is capable of transferring a virtually unlimited amount of data between a virtually unlimited number of computers using a de-centralized approach to minimize operating and computational costs.

According to this disclosure, one or more synchronization networks are constructed, preferably by arranging an ordered list of resource identifiers (e.g., IP addresses and/or other parameters) into connected circle graphs, ensuring geographic optimization where nearby computers can communicate with each other efficiently. This approach minimizes bandwidth usage, increases response time and distributes the computational load across participating computers.

According to a more specific aspect, a method is operated at a coordinating entity to organize a set of hosts into a synchronization network. The coordinating entity maintains information that a particular host is online and available to be organized into the synchronization network. To that end, the coordinating entity assigns an identifier (a node identifier) to each host that is online, and that identifier is unique within the particular synchronization network. The coordinating entity then orders the node identifiers for the set of hosts (based on a given characteristic of the node identifiers). In one embodiment, the ordering organizes the synchronization network in a particular topography, such as a circle. Based on the ordering, the coordinating entity provides each host that is online with a list of K online hosts to enable each host to establish and maintain connections with K of its neighbor hosts. In this scheme, K is a value that is the same for all hosts within the synchronization network.

The foregoing has outlined some of the more pertinent features of the subject matter. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an extensible Web-based remote access architecture in which exemplary aspects of the synchronization method of this disclosure may be implemented;

FIG. 2 is an illustrative synchronization network according to this disclosure;

FIG. 3 is a simple connected circle graph comprising a synchronization network;

FIG. 4 illustrates how selected nodes in the connected circle graph are connected to one another according to the techniques of this disclosure; and

FIG. 5 illustrates a technique for implementing a crossover connection according to a variant of the disclosed scheme.

### DETAILED DESCRIPTION OF AN ILLUSTRATIVE EMBODIMENT

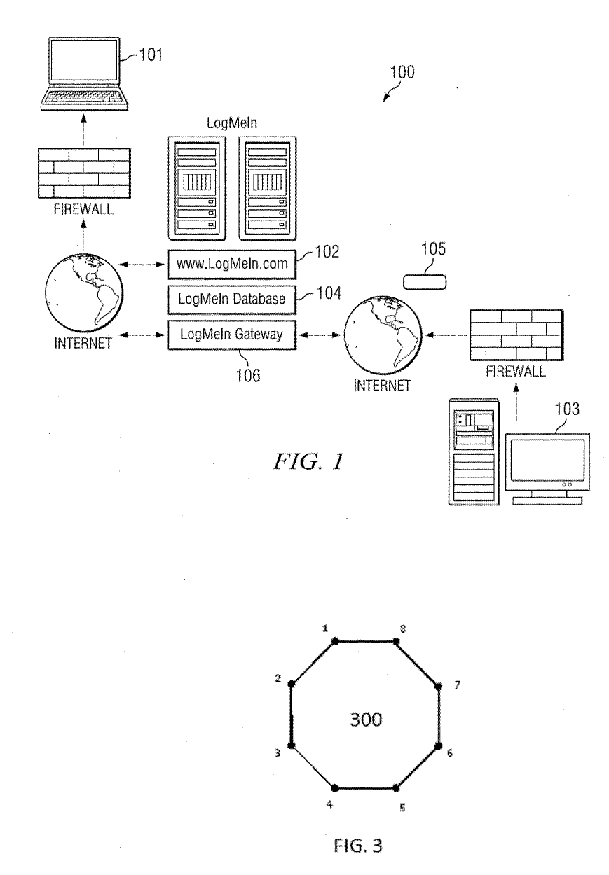

FIG. 1 illustrates a high level view of a remote access architecture 100 in which the disclosed technique may be practiced. This architecture is merely representative, and it should not be taken as limiting. Preferably, the architecture comprises “n-tiers” that include a web server tier 102, a database tier 104, and a gateway tier 106. The web server tier 102 comprises a plurality of machines that each executes web server software. The web server tier provides an Internet-accessible web site. Preferably, the web site associated with a site domain (however designated) is available from multiple locations that collectively comprise the web server tier 102. The database tier 104 comprises a plurality of machines that each executes database server software. The database tier provides a network-accessible data storage service for generating and storing data associated with end user sessions to the remote access service. The gateway tier 106 comprises a plurality of machines that each executes application server software. The gateway tier provides a network-accessible connection service for establishing and maintaining connections between and among the participating end user computers. Although not shown, preferably end user computers connect to the gateway servers over secure connections, e.g., over SSL, TLS, or the like. A representative machine on which the web server, database server or gateway server executes comprises commodity hardware (e.g., one or more processors) running an operating system kernel, applications, and utilities. In the remote access architecture, a computer or other device 101 uses the illustrated infrastructure to access or remotely control a host computer or device 103. In a representative embodiment, the architecture provides a Web-based remote access service, such as LogMeIn®.

### Building/Managing Synchronization Networks

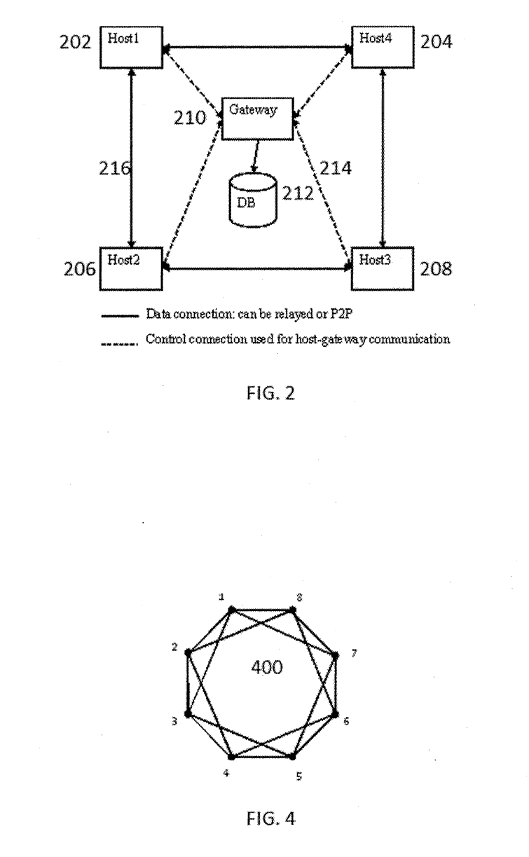

The following describes a technique to build a network capable of transferring virtually unlimited amount of data between virtually unlimited amount of computers, with low operating and computational costs. For convenience of description, the network is sometimes referred to herein as a “synchronization network” (or a “sync network”). Using the remote access architecture of FIG. 1 as representative, a synchronization network 200 according to this disclosure is represented in FIG. 2. Network 200 comprises hosts 202, 204, 206 and 208, gateway 210, and database 212. A host is sometimes referred to herein as a “client” or a “node.” In this example scenario, which is not meant to be limiting, the hosts correspond to the computers (such as 101 or 103) that use the service infrastructure. The web tier is omitted for convenience. For scalability, the gateway 210 and database 212 may comprise components of a tiered infrastructure, as previously described. Thus, as used herein, a “gateway” may refer to one or more such gateways, and a “database” may refer to one or more such databases. Generalizing, a gateway, a database, a host, or the like is a computing entity that is typically a network-accessible computing machine or device with suitable hardware, software, storage, and input/output devices.

In this architecture, the gateway 210 coordinates hosts 202, 204, 206 and/or 208 using a control connection (dotted line 214), and the gateway 210 also relays data between hosts that are not capable of communication in a non-relayed manner (solid line 216). The database (DB) 212 holds host details (e.g., name, ID, online status, description, IP address, geo-location, and the like), assignments of hosts and synchronization network, and other information as necessary to build up and optimize networks, as will be described in more detail below. Together, the gateway 210 and its associated database 212 comprise a coordinating entity that organizes and maintains a synchronization network. The data connection (the solid line 216) is a connection that transfers application data between hosts. The control connection (the dotted line 214) is a connection that hosts use to communicate with the gateway 210. Preferably, no application data is transferred over the control connection, although this is not a limitation.

According to this disclosure, a plurality or set of hosts are organized by the coordinating entity into one or more synchronization network(s), and (as noted above) there may be multiple gateways/databases. The number of hosts that comprise a particular synchronization network at any time may vary, as one or more hosts “leave” the network or “join” the network. Thus, the synchronization network (as an overall entity) is a dynamic construct that may be changing randomly or deterministically.

For convenience, a host is sometimes referred to herein as a participating machine (typically, e.g., hardware and software components supported thereon). For discussion purposes, a machine is referred to sometimes as a “computer” but this is not a limitation in that it implies a fixed computing resource. A participating machine may be a handheld or mobile device, such as any wireless client device, e.g., a cellphone, pager, a personal digital assistant (PDA, e.g., with GPRS NIC), a mobile computer with a smartphone client, or the like. More generally, a host is an endpoint of a communication. According to this disclosure, with respect to a particular synchronization network, endpoints are first assigned a unique ID (NodeID) (or, more generally, a “node identifier”) and ordered into a graph, such as a “circle” graph. Each node is then responsible for ensuring it is always connected to its nearest K neighbors where K≧2. By selecting the NodeID prudently, this approach guarantees that related computers are close to each other in a circle graph. Preferably, the logic for creating the NodeID is maintained in the coordinating entity database 212; as a consequence, an optimization can be changed at any time without endpoint deployment. As will also be described in more detail below, this circle graph can be further optimized by introducing so-called “crossover” connections between distant nodes.

Thus, according to an embodiment, a unique ID (NodeID) is created and assigned to each endpoint in a synchronization endpoint. As noted above, a particular machine may be (and often is) an endpoint in more than one synchronization network. In one embodiment, tndpoints form a circle (or circular) network in which they are ordered by their NodeID. NodeIDs are configured such that related computers are near each other. For example, to organize computers by their geographical distance (which is not a limitation), a NodeID utilizes an IP address with some additional network related parameters. This embodiment is described in more detail below.

The following provides additional details regarding this technique. By way of background, the problem of making sure that a network (graph) with arbitrary topology is connected requires that the coordinating entity be aware when computers are added to the network, computers are removed from the network, computers come online, and computers go off-line. According to a feature of this disclosure, the computational cost for keeping the network “connected” is dramatically reduced by using a graph topology, such as a circle graph. This is because a circle graph always stays connected if all nodes have at least K≧2 neighbors, where K is the degree of a node. FIG. 3 represents an example circle graph 300, where K=2. The graph in this example includes eight (8) nodes, which are typically hosts that, together with the coordinating entity (not shown) comprise the synchronization network. Connectivity by and among the participating nodes is managed by a management routine (e.g., as a set of computer program instructions executed in a processor) executing within (or by) the coordinating entity. This routine, referred to as GetClosestOnlineHost for convenience, works generally as follows. The routine marks all connections that are needed to build up a particular circle graph (a synchronization network) as “mandatory.” Certain connections are marked as optional. These include so-called “crossover” connections, which are used for optimization purposes, as will be described. When a client node comes online, it receives (from the coordinating entity) a list of “K” connections that are marked as “mandatory.” The host also calls the gateway GetClosestOnlineHost routine when one of its mandatory connections is lost.

According to this disclosure, the above network is sustained (for connectivity purposes) by enforcing a pair of rules: (1) nodes within the network are ordered, and (2) each host is always connected with exactly K of their nearest online neighbors.

Thus, according to this technique, when some particular set of hosts need to communicate among each other, a circle network is created. The following algorithm may be used to build up such a network.

### Presumptions

Preferably, each host knows the following:
   List of sync networks to which it has access; this information is provided to the host by the gateway/database.
   List of hosts for each network, to where the host should be connected; this information is sent by the gateway/database.
   Flag for each connection, e.g., whether the connection is mandatory, or optional (which is the case for a “crossover” connection).
   Flag to determine the type of connection (e.g., TCP/XTCP/Relayed).
   The host need not know (and does not know) the online status of the other hosts
Preferably, the gateway knows the following information:
   The online status of each host, which information is supplied by the database
   The node identifier (NodeID) of each host, which information is supplied from the database. The NodeID is unique for a particular synchronization network and may be calculated based on a host identifier, an IP address and one or more other flags associated with the host. The NodeIDs are used to sort the hosts in a sync network.
   The associations of hosts and sync networks, also supplied from the database.

### Algorithm

With the above as the preferred constraints, the following algorithm is then used to create and maintain a synchronization network:
a) Each host gets a list from the gateway of the K nearest online hosts. The gateway (GW) queries the database (DB) for the list and returns it to the host.
b) The host initiates a connection to each host returned in this list. If any of the connection attempts fail, the host downloads the list from the gateway again.
c) If there are peer-to-peer or direct TCP connections that are not in the list, the host leaves those connections active; relayed connections, however, are closed by the host.

Thus, according to the disclosed technique, each synchronization networks forms a graph, such as a circle graph. Within the circle graph, hosts are ordered by the NodeID. Each host maintains connections with K of its closest neighbors. By default, K is the same for all hosts within a sync network but, preferably, its value depends on the number of hosts (N) in the network. FIG. 4 represents such a synchronization network, which implements a P2P topology (N=8, K=4).

According to the algorithm, a host is responsible for ensuing it is always connected with exactly K of its nearest online neighbors. Preferably, a host initiates a connection in two steps, which are now described. First, the host indicates to the gateway that a new connection is needed, forwarding a host identifier. This communication also requests that the gateway provide the requesting host with the host's closest online hosts. The gateway executes a “get closest online hosts” routine for this purpose. The gateway responds to the communication and the request by obtaining (from the database) the “K” nearest online neighbors of the node of network. The gateway provides this “list” to the requesting host. The host, having received the list from the gateway, then starts connecting one by one to the nodes identified in the list. If any such connection attempt returns an error, preferably the host calls the gateway and again requests the lists of its closest online neighbors.

When a host loses any of its mandatory connections, preferably it calls the gateway's “get closest online hosts” routine to attempt to maintain the circle graph. The host need not call this function when an extra connection builds up from another host, however.

The technique provides numerous advantages. It provides a highly scalable and optimized network enabling the efficient transfer of data while minimizing operating cost. The technique is much more scalable and cost effective than current approaches, based on the non-centralized architecture and unique use and assignment of NodeID's resulting in an efficient and optimized network. The technique enables hosts to create a peer-to-peer network that spares server and database resources by eliminating the need for centrally maintained connections. The technique optimizes the network from an arbitrary perspective, and the connection logic can be changed in a central database without any need to deploy or change the endpoint software. The technique also is advantageous as it favors P2P connections and limits the number of relayed connections. It also ensures that the nodes that are physically closer are likely to be connected, which provides geographic balancing. In addition, the technique provides a degree of bandwidth balancing, as hosts with stronger bandwidth/capacity typically have more connections.

The “ordering” of the NodeIDs may be based on one or more characteristic(s) of the identifiers. In one non-limiting embodiment, the ordering is based on byte order for the IP addresses of the hosts. In an alternative, the ordering is based on the values generated by concatenating a host IP address with an additional value, where the additional value is one of: a flag representing a P2P capability associated with the host, a load associated with the host, an amount of storage or processing capability associated with the host, a latency associated with the host, geo-data associated with the host, other physical, network and/or content characteristics, or some combination thereof.

Preferably, the NodeID is unique within a particular synchronization network. Preferably, and as noted above, the NodeID is numerical, which facilitates the defining of an ordering amongst the hosts that are participating in the sync network. As noted above, each host maintains connections with K of its closest neighbors, where K is the same for all hosts within a given sync network. The value K may be dynamically configurable. By selecting the NodeID prudently, the technique described herein ensures that related computers are close to each other in a circle graph. By maintaining the logic for creating the NodeID only in the gateway and/or database, the logic can be changed at any time without host deployment changes.

As described above, preferably the NodeID is created such that the most significant bytes are comprised of the public IP address of the host. This approach provides several benefits. First, nodes that are on the same physical local area network (LAN) typically share the same public IP address. Therefore, if two nodes (from the same LAN) are next to each other in the graph, they can easily connect to each other, e.g., by using a P2P connection library that is capable of establishing a direct LAN (or hairpin NAT) connection, and this connection may be made without leaving the LAN (thus resulting in no Internet traffic). Further, nodes that are on the same ISP likely have the same class C or class B subnet; therefore, they will connect to each other as well, thereby minimizing the amount of traffic that has to leave the ISP's network.

### Crossover Connections for Synchronization Networks

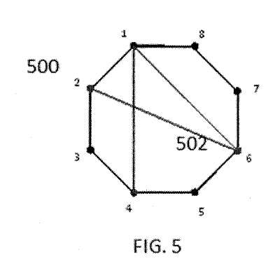

As a particular circle graph becomes large, communications between distant points can become slow as the number of hops between the hosts increases. To address this issue, a particular circle node can be optimized by creating additional crossover connections between particular (distant) endpoints. These are so-called “crossover” connections, such as connection 502, as indicated in the example network 500 shown in FIG. 5.

One technique for implementing such crossover connections is extending the circle graph buildup algorithm (get closest online hosts) to include an arbitrary number (L, where L≧0) of distant hosts, in addition to the ‘K’ nearest online hosts. These connections are not mandatory so if they fail to build up, the host does not necessarily have go back to the GW for a new list. By creating crossover connections between distant nodes that are capable of communicating in a non-relayed manner reduces the amount of relayed traffic, which results in a more cost-efficient and better performance network.

Although not meant to be limiting, the controlling entity may select the zero or more optimization connections randomly, deterministically, or a combination thereof. In one approach, the controlling entity selects the furthest host across the diameter of the circle graph.

The controlling entity can cause the initiation of a crossover connection by providing a host in the synchronization network with an additional node identifier (or multiple such identifiers). An additional node identifier identifies a crossover (non-relayed) connection between the host and at least one neighbor host. An entity that receives an additional node identifier uses that identifier to establish and maintain a crossover connection (if it can do so). The host need only maintain the crossover connection if it can be a non-relayed connection; otherwise, the connection need not be maintained. The controlling entity may provide a host zero or more crossover connections as needed or desired to optimize the synchronization network. While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

Having described our invention, what we now claim is as follows.

1. A method, operating at a coordinating entity, of organizing a set of hosts into a synchronization network, comprising:
maintaining information indicating that a host is online and available to be organized into the synchronization network;
assigning a node identifier to each host that is online, the node identifier being unique within the synchronization network;
ordering the node identifiers for the set of hosts; and
based on the ordering, providing each host that is online with a list of K online hosts to enable each host to establish and maintain connections with K of its neighbor hosts, where K is a value that is the same for all hosts within the synchronization network; and
providing a host in the synchronization network with zero or more additional node identifiers, each additional node identifier identifying at least one neighbor host that is not then in direction connection with the host, the additional node identifier identifying a crossover connection between the host and the at least one neighbor host.

2. The method as described in claim 1 wherein, as a result of the ordering, the synchronization network is organized as a circle.

3. The method as described in claim 1 wherein node identifier is assigned based on one of: an IP address of the host, and geo-data associated with the host.

4. The method as described in claim 3 wherein the node identifier is assigned based on an IP address of the host and an additional value.

5. The method as described in claim 4 wherein the additional value identifies one of: a P2P capability associated with the host, a load associated with the host, a latency associated with the host, and a combination thereof.

6. The method as described in claim 1 wherein the node identifiers are ordered according to a predetermined criterion.

7. The method as described in claim 1 wherein the information also includes an identification of a one or more other synchronization networks in which a particular host is already connected.

8. The method as described in claim 1 wherein each host is responsible for maintaining connections with K of its neighbor hosts, and the host that receives the additional node identifier is responsible for attempting to maintain the crossover connection.

9. The method as described in claim 1, further including receiving, from a host, an indication that a new connection is required and, in response, providing a new ordering.

10. The method as described in claim 1, further including providing the ordering in response to receipt of an indication from a host that a connection attempt has failed.

11. The method as described in claim 1 wherein a host operates a remote access client.

12. The method as described in claim 1 wherein the coordinating entity is a gateway having a database associated therewith.

13. Apparatus for organizing a set of hosts into a synchronization network, comprising:
a processor;
computer memory holding computer program instructions executed by the processor to perform a method, comprising:
maintaining information indicating that a host is online and available to be organized into the synchronization network;
assigning a node identifier to each host that is online, the node identifier being unique within the synchronization network;
ordering the node identifiers for the set of hosts; and
based on the ordering, providing each host that is online with a list of K online hosts to enable each host to establish and maintain connections with K of its neighbor hosts, where K is a value that is the same for all hosts within the synchronization network; and
providing a host in the synchronization network with zero or more additional node identifiers, each additional node identifier identifying at least one neighbor host that is not then in direction connection with the host, the additional node identifier identifying a crossover connection between the host and the at least one neighbor host.

14. The apparatus as described in claim 13 wherein each host is responsible for maintaining connections with K of its neighbor hosts, and the host that receives an additional node identifier is responsible for attempting to maintain the crossover connection.

15. The apparatus as described in claim 13 wherein the node identifier is assigned based on an IP address of the host and an additional value.

16. The apparatus as described in claim 15 wherein the additional value identifies one of: geo-data associated with the host, a P2P capability associated with the host, a load associated with the host, a latency associated with the host, and a combination thereof.

17. The apparatus as described in claim 13 wherein the node identifiers are ordered according to a predetermined criterion.

18. The apparatus as described in claim 13 wherein the information also includes an identification of a one or more other synchronization networks in which a particular host is already connected.

19. The apparatus as described in claim 13, wherein the method further includes receiving, from a host, an indication that a new connection is required and, in response, providing a new ordering.

20. The apparatus as described in claim 13, wherein the method further includes providing the ordering in response to receipt of an indication from a host that a connection attempt has failed.
